(19) United States
(12) Patent Application Publication
(10) Pub. No.: US 2026/0356287 A1
(43) Pub. Date: Nov. 12, 2026

(54) Vehicle Interior Trim Device

(71) Applicant: Bayerische Motoren Werke Aktiengesellschaft, Muenchen (DE)

(72) Inventors: Saad AHMED, Muenchen (DE); Alexander Eichner, Reichertshausen (DE); Markus Haertl, Zorneding (DE); Said Kijamet, Muenchen (DE); Maxime Le Rallic, Moosburg an der Isar (DE)

(21) Appl. No.: 19/668,913

(22) Filed: May 6, 2026

(30) Foreign Application Priority Data
May 7, 2025 (DE) 10 2025 117 398.2

(51) Int. Cl. B60Q 3/78; B60Q 3/54; B60Q 3/64

(52) U.S. Cl. CPC B60Q 3/78; B60Q 3/54; B60Q 3/64

(57) ABSTRACT

A vehicle interior trim device, which can also be called a vehicle interior decorative device, has a plurality of vertical bars, which are arranged in parallel, in particular are spaced apart from each other. Furthermore, the vehicle interior trim device has a lighting device with a light source, in particular an LED light source with, for example, a plurality of individually controllable LEDs, for illuminating the vertical bars.

### CROSS REFERENCE TO RELATED APPLICATION

This application claims priority under 35 U.S.C. §119 from German Patent Application No. 10 2025 117 398.2, filed May 7, 2025, the entire disclosure of which is herein expressly incorporated by reference.

### BACKGROUND AND SUMMARY

This disclosure relates to a vehicle interior trim device.

A known motor vehicle has a vehicle interior for vehicle occupants, in particular a driver. A vehicle interior of this kind is provided with trim elements which have a decorative but also insulating (sound, heat) as well as protective function. Trim elements of this kind may also have an integrated safety function for absorbing an impact or clear space for deployment of an airbag. Trim elements are arranged in the region of a vehicle roof, on inner sides of vehicle body pillars, on inner sides of doors, in the region of an instrument panel and a center console region, or else in a luggage compartment. Trim elements usually have a substantially smooth surface made of plastic, possibly laminated plastic, leather or a textile.

An object of the present disclosure is to provide a vehicle interior trim device which allows additional illumination of a vehicle interior, in particular with better light reflection.

According to the disclosure, a vehicle interior trim device, which can also be called a vehicle interior decorative device, has a plurality of vertical bars, which are arranged in parallel, in particular are spaced apart from each other. Furthermore, the vehicle interior trim device has a lighting device with a light source, in particular an LED light source with, for example, a plurality of individually controllable LEDs, for illuminating the vertical bars.

This advantageously results in indirect illumination of the vehicle interior by illuminating the bars. Furthermore, the bars have an acoustically damping effect in the vehicle interior.

The vertical bars have a certain extent in their respective vertical direction. Furthermore, the vertical bars have only a small thickness or width in relation to their length and height. The vertical bars therefore have a wing-like or plate-like geometry.

The geometry of the vertical bars is preferably substantially of structurally the same or identical design.

The plurality of vertical bars are advantageously connected to each other in one piece and produced, for example, by plastic injection molding.

According to a preferred embodiment, the lighting device is arranged at a level below the vertical bars. The lighting device is adapted to emit light onto front edges of the vertical bars. Front free edges, that is to say free edges directed toward an interior or toward a vehicle occupant, of the bars are preferably lit or illuminated by the lighting device.

According to a preferred development, the lighting device emits light onto the vertical bars through a light diffuser, that is to say a diffuser plate. The light diffuser is configured in such a way that the light is scattered and uniformly emitted onto the vertical bars.

A light exit region of the lighting device is preferably substantially not directly visible to a vehicle occupant in their intended seating position owing to a corresponding panel device. That is to say, the light diffuser is arranged behind the panel device outside a line of sight of the vehicle occupant.

The illuminated vertical bars therefore look as if they themselves were illuminated.

Furthermore, the lighting device advantageously has a light guide, which guides light from the light source to the light diffuser.

The light guide and the light source can advantageously extend over an entire width of the vehicle interior trim device. As a result, each bar can be lit in the same way.

According to a further development, the vehicle interior trim device can have an air outflow region, which is arranged at least in portions behind the vertical bars. The air outflow region is connected to a vehicle air-conditioning device, which conducts temperature-controlled air into the vehicle interior. The temperature-controlled air flows between the vertical bars into the vehicle interior.

An air vent is thus integrated into the vehicle interior trim device such that it is substantially invisible.

Movable, in particular rotatable, for example horizontally or/and vertically running, air-guiding slats are preferably arranged in an air outflow channel of the air vent behind-that is to say on a side facing away from the vehicle interior-the vertical bars. An outflow direction of the outflowing air can advantageously be adjusted by corresponding movement or rotation of the air-guiding slats. A horizontal movable air-guiding slat or a plurality of horizontal movable air-guiding slats can be arranged one above the other spaced apart from each other in the air outflow channel. A vertical air-guiding slat or a plurality of vertical air-guiding slats can be arranged next to each other spaced apart from each other in the air outflow channel.

Vertical movable air-guiding slats are preferably arranged adjacent to the vertical bars, wherein a vertical air-guiding slat is aligned with a respective associated vertical bar. A rotation axis of the vertical air-guiding slat is formed in particular adjacent to the vertical bar. As a result, the vertical air-guiding slats are not visible to a vehicle occupant in the interior and are positioned favorably in terms of flow mechanics, that is to say with a low air resistance.

The horizontal air-guiding elements, the vertical air-guiding elements and the vertical bars are preferably arranged one behind the other in this order in the direction of the flowing air.

According to a preferred development of the vehicle interior trim device, the vertical bars are arranged substantially in a region of half a width of an instrument panel. The vertical bars can advantageously extend substantially over an entire width of the instrument panel.

The vehicle interior trim device is preferably level with displays or a so-called instrument cluster or at a level at which air outlets for central interior air-conditioning are usually located, this not meaning the air outlets for the footwell or for the headspace or for the windshield. The vehicle interior trim device can further advantageously run over a steering column. A glove compartment on a passenger side is located in particular beneath the vehicle interior trim device.

The vertical bars can be arranged with a spacing of approximately 2 mm to approximately 25 mm, preferably 2 mm to 12 mm, for example 8 mm, in each case.

The spacing between adjacent vertical bars is preferably the same. As an alternative, the spacing between adjacent bars in one direction can become increasingly larger or smaller. Similarly, a thickness of adjacent bars in one direction can increase or decrease.

The abovementioned features can be freely combined with each other as far as possible and expedient.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 is a sectional view of a vehicle interior trim device parallel to an xz plane in a region in which there is no air vent according to a first exemplary embodiment of the present disclosure.

FIG. 2 is a schematic, perspective sectional view of the vehicle interior trim device parallel to the xz plane in the region in which there is no air vent according to the first exemplary embodiment of the present disclosure.

FIG. 3 is a schematic perspective view of a vehicle interior trim device in an instrument panel according to the first exemplary embodiment of the present disclosure.

FIG. 4 is a schematic, perspective sectional view of the vehicle interior trim device parallel to the xz plane in a region of an air vent according to the first exemplary embodiment of the present disclosure.

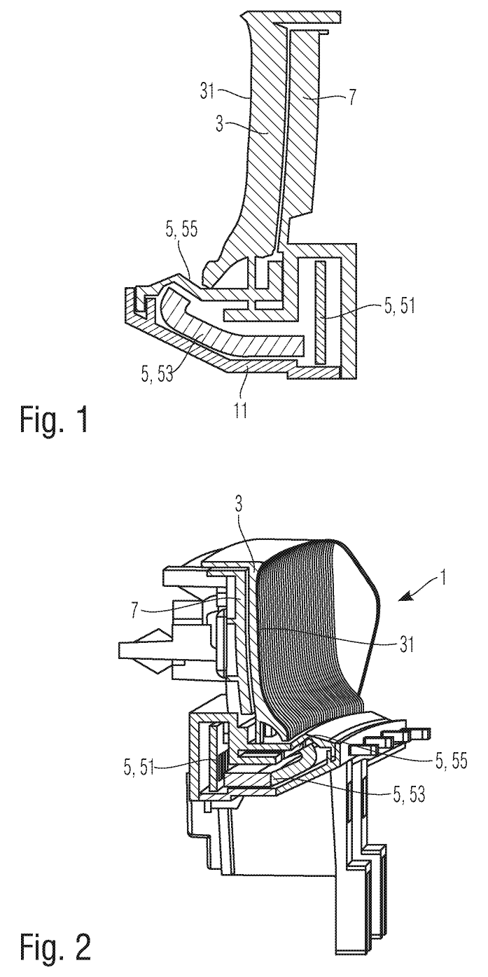

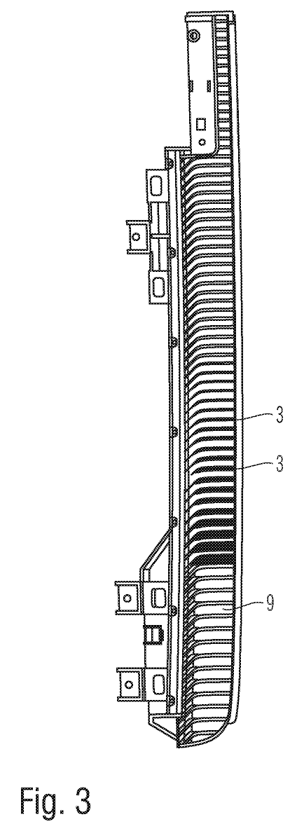

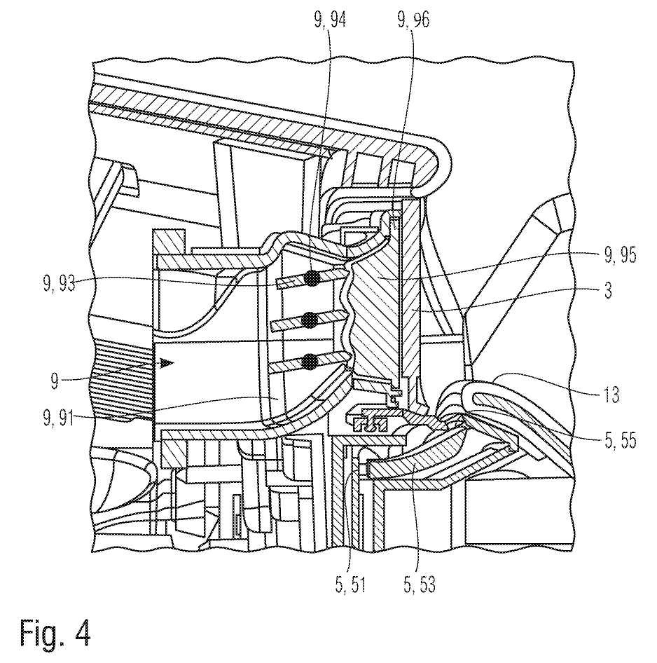

### DETAILED DESCRIPTION OF THE DRAWINGS

In the following detailed description of a vehicle interior trim device 1, directional indications are made from the perspective of a vehicle interior or vehicle occupant, and not with respect to a main direction of travel of a passenger motor vehicle in which the vehicle interior trim device 1 is fitted.

The vehicle interior trim device 1 according to the exemplary embodiment of the present disclosure is attached to an instrument panel or is part of an instrument panel of the passenger motor vehicle. The vehicle interior trim device 1 extends substantially over an entire width of the instrument panel. The instrument panel extends over an entire width of the vehicle interior between A-pillars of the passenger motor vehicle and behind a windshield in the main direction of travel of the passenger motor vehicle. The vehicle interior trim device 1 has a plurality of vertical, wing-like bars 3 which are arranged in parallel and are uniformly spaced apart from each other. The bars 3 are each arranged substantially parallel to an xz-plane, that is to say a plane in the vehicle vertical direction and in the vehicle longitudinal direction. A free edge of the bars 3 faces the vehicle interior or a vehicle occupant in the vehicle interior. From the perspective of the vehicle occupant, this results in a transversely extending band in which parallel, vertical bars are arranged.

In the exemplary embodiment, the geometry of the vertical, wing-like bars 3 is of similar, structurally the same or identical design. However, the bars 3 could also have different thicknesses, for example a thickness of the bars 3 decreases in the direction of one vehicle side.

Furthermore, the vehicle interior trim device 1 has a lighting device 5 with a light source 51 consisting of a plurality of LEDs, that is to say light-emitting diodes, which are arranged next to each other and, from the perspective of the vehicle occupant, beneath the bars 3 and behind the bars 3. The LEDs can be individually controlled and can be illuminated in different colors.

The light from the light source 51, that is to say the plurality of LEDs, is coupled into a light guide 53, which extends in front of the light source 51 from the perspective of the vehicle occupant. The light source 51 likewise extends, corresponding to the bars 3, over a width of the instrument panel, so that the light source 51 is arranged in the region of each bar 3. The light guide 53 also correspondingly extends over a width of the instrument panel. A light diffuser 55, which can also be called a diffuser plate, is arranged at one end of the light guide 53 and likewise extends over the width of the instrument panel analogously to the light guide 53. The light from the light source 51 is coupled out at the end of the light guide 53, passes through the light diffuser 55 and hits the bars 3, in particular the front edges 31 of the bars 3. The light diffuser 55 is arranged behind a screen 13, which is formed in one piece with the light diffuser 55. The light diffuser 55 is therefore outside a field of view or line of sight of the vehicle occupant, so that the vehicle occupant does not see the light diffuser 55 and the light emerging there. However, the vehicle occupant sees the light which hits the bars 3, in particular the front edges 31 of the bars 3.

The light source 51 with the plurality of LEDs can be controlled by way of a light control device, in particular the LEDs can be individually controlled, so that a dynamic, color-changing lighting presentation of the vehicle interior trim device 1 is possible by way of the light control device. The light control device may comprise a processor configured to executed software, instructions, and/or logic stored in a memory. The lighting presentation can be automatically adapted depending on times of day, driving modes, personal presets, interior noise (in particular from the entertainment system, for example music), the external environment, weather conditions, brightness and/or navigation data etc. The lighting presentation includes colors and brightness. The lighting presentation can include moving images.

Illumination of the bars 3 advantageously results in indirect illumination of the vehicle interior.

The vehicle interior trim device 1 according to the exemplary embodiment is constructed from several parts. In particular, the vehicle interior trim device 1 has a bar component, which connects the bars 3 to each other in one piece. Furthermore, the vehicle interior trim device 1 has a rear wall component 7 which is arranged behind the bars 3 and forms a wall behind the bars 3 and also serves as a mount for the light source 51. Furthermore, the vehicle interior trim device 1 has a bottom component 11 which is fitted to the bar component and the rear wall component 7 from below.

The vehicle interior trim device 1 is in turn fitted to the instrument panel as an assembly.

The vehicle interior trim device 1 can also extend only over approximately half the width of the instrument panel. Two vehicle interior trim devices are then preferably arranged next to each other.

The bar component, the rear wall component 7 and the bottom component 11 are produced by plastic injection molding.

Furthermore, according to the exemplary embodiment, an air vent 9 of a vehicle air-conditioning system is arranged behind the vehicle interior trim device 1 - from the perspective of the vehicle occupant. The vehicle interior trim device 1 has a corresponding opening in the rear wall component 7 at the location of the air vent 9, or the rear wall component 7 is not present at this location. Air can thus flow from the air vent 9, through the intermediate space between the bars 3, into the vehicle interior.

The air vent 9 has an air duct 91 adjacent to the vehicle interior trim device 1, wherein three horizontal air-guiding slats 93, each rotatable about a horizontal axis 94, are arranged in the air duct 91 close to the bars 3. Furthermore, vertical air-guiding slats 95, each rotatable about a vertical axis 96, are arranged substantially adjacent to the bars 3 and the horizontal air-guiding slats 93, that is to say between the bars 3 and the horizontal air-guiding slats 93. Each vertical axis 96 of a vertical air-guiding slat 95 is arranged adjacent to an associated vertical bar 3. Each vertical air-guiding slat 95 is aligned with the associated vertical bar 3 in a central position. As a result, the vertical air-guiding slats 95 are barely visible to a vehicle occupant since they are concealed by the vertical bars 3. Since the horizontal air-guiding slats 93 are arranged somewhat spaced apart from the vehicle interior, that is to say are arranged further to the rear in the air duct 91 as viewed from the vehicle interior, the horizontal air-guiding slats 93 are likewise barely visible to a vehicle occupant. A direction of the air flowing out into the vehicle interior can be adjusted by way of the air-guiding slats 93, 95. The air vent 9 is thus concealed behind the vehicle interior trim device 1 or behind the bars 3 such that it is barely visible.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

What is claimed is:

1. A vehicle interior trim device comprising:
a plurality of vertical bars, which are arranged in parallel and are spaced apart from each other, and
a lighting device with an LED light source, for illuminating front vertical edges of the vertical bars.

2. The vehicle interior trim device according to claim 1, wherein the lighting device is arranged beneath the vertical bars and is adapted to emit light onto front edges of the vertical bars.

3. The vehicle interior trim device according to claim 1, wherein the lighting device emits light onto the vertical bars through a light diffuser, wherein the light diffuser is configured such that the light can be emitted substantially uniformly onto the vertical bars.

4. The vehicle interior trim device according to claim 3, wherein the light diffuser is arranged behind a panel outside a field of view of a vehicle occupant.

5. The vehicle interior trim device according to claim 3, having a light guide, which guides light from the light source to the light diffuser.

6. The vehicle interior trim device according to claim 1, further having at least one air vent, which is arranged at least in portions behind the vertical bars.

7. The vehicle interior trim device according to claim 6, wherein horizontally running movable air-guiding slats and/or vertically running movable air-guiding slats, are arranged behind the vertical bars in an air outflow channel.

8. The vehicle interior trim device according to claim 7, wherein a vertical air-guiding slat is aligned with a respective associated vertical bar and a rotation axis of the vertical air-guiding slat is formed in particular adjacent to the vertical bar.

9. The vehicle interior trim device according to claim 1, wherein the vertical bars extend substantially over at least half a width of an instrument panel.

10. The vehicle interior trim device according to claim 1, wherein the vertical bars have a spacing of 2 mm to 25 mm.
